(19) United States
(12) Patent Application Publication
(10) Pub. No.: US 2015/0127889 A1
(43) Pub. Date: May 7, 2015

(54) NONVOLATILE MEMORY SYSTEM

(71) Applicant: THE-AIO INC., Seongnam-si, Gyeonggi-do (KR)

(72) Inventor: Sun-Mo Hwang, Suwon-si (KR)

(73) Assignee: THE-AIO INC., Seongnam-si, Gyeonggi-do (KR)

(21) Appl. No.: 14/398,009

(22) PCT Filed: Apr. 18, 2013
(86) PCT No.: PCT/KR2013/003309

§ 371 Date: Oct. 30, 2014

(30) Foreign Application Priority Data
May 3, 2012 (KR) 10-2012-0047076

(51) Int. Cl. G06F 12/02

(52) U.S. Cl. CPC G06F 12/0253; G06F 12/0246; G06F 2212/7205; G06F 2212/7211
USPC 711/103

(57) ABSTRACT

A non-volatile memory system includes a NAND flash memory device including a first flash translation layer that performs a garbage collection operation, and a host device including a file system and a second flash translation layer that controls an operation of the NAND flash memory device by interacting with the file system. Here, the host device provides application data in an in-ordered form to the NAND flash memory device. Thus, the non-volatile memory system can perform a random write operation at high speed, and can minimize power consumption due to unnecessary data transfer.

### CROSS-REFERENCE TO RELATED APPLICATION(S)

This application claims priority under 35 USC §119 to Korean Patent Application No. 10-2012-0047076, filed on May 3, 2012 in the Korean Intellectual Property Office (KIPO), the contents of which are incorporated herein in its entirety by reference.

### BACKGROUND

1. Technical Field

Example embodiments relate generally to a semiconductor memory system. More particularly, embodiments of the present inventive concept relate to a non-volatile memory system including a NAND flash memory device.

2. Description of the Related Art

Generally, a semiconductor memory device may be classified into two types (i.e., a volatile memory device and a non-volatile memory device) according to whether data can be retained when power is not supplied. Recently, a NAND flash memory device is widely used as the non-volatile memory device because the NAND flash memory device can be made smaller while having higher capacity. However, since the NAND flash memory device cannot perform an overwrite operation unlike a Hard-Disk Drive (HDD), the NAND flash memory device updates data by programming an update page in a log block associated with a data block and by performing an address-mapping related thereto. Here, the address-mapping is performed by a Flash Translation Layer (FTL) in the NAND flash memory device. As a result, a target page (or, victim page) to be updated becomes an invalid page, and an update page for the target page becomes a valid page.

Thus, since valid pages and invalid pages are dispersed in several blocks due to characteristics of the NAND flash memory device, a garbage collection operation should be performed in the NAND flash memory device. Here, the garbage collection operation includes a merging operation for securing free blocks by merging the valid pages and by erasing the invalid pages, a compaction operation for optimizing the blocks by moving the valid pages, a wear-leveling operation for equalizing wear of memory cells, etc. However, the garbage collection operation results in time delay, additional data transfer, etc, so that overall performance of the NAND flash memory device may be degraded by the garbage collection operation. For this reason, many studies for efficiently performing the garbage collection operation for the NAND flash memory device have been actively carried out, conventional techniques have fundamental limits because the conventional techniques mostly depend on only the FTL to perform the garbage collection operation.

### SUMMARY

Some example embodiments provide a non-volatile memory system in which a host device (i.e., a file system and a second flash translation layer included in the host device) provides application data in an in-ordered form to a NAND flash memory device, and the NAND flash memory device (i.e., a first flash translation layer included in the NAND flash memory device) performs a garbage collection operation.

According to an aspect of example embodiments, a non-volatile memory system may include a NAND flash memory device including a first flash translation layer that performs a garbage collection operation, and a host device including a file system and a second flash translation layer that controls an operation of the NAND flash memory device by interacting with the file system. Here, the host device may provide application data in an in-ordered form to the NAND flash memory device.

In example embodiments, the garbage collection operation that is performed by the first flash translation layer may include at least one selected among a merging operation, a compaction operation, and a wear-leveling operation.

In example embodiments, the second flash translation layer of the host device may provide the application data in the in-ordered form.

In example embodiments, the file system of the host device may provide the application data in the in-ordered form.

In example embodiments, an address-mapping that is performed by the first flash translation layer may correspond to a block mapping.

In example embodiments, the NAND flash memory device may perform an in-ordered write operation for a target data block in response to an in-ordered write command when the host device outputs the in-ordered write command indicating (or, related to) the target data block to the NAND flash memory device.

In example embodiments, when a target page to be updated exists among valid pages included in the target data block, the NAND flash memory device, the NAND flash memory device may program an update page for the target page after copying the valid pages preceding the target page into a log block associated with the target data block.

In example embodiments, the NAND flash memory device may perform the garbage collection operation for a target data block in response to a block deactivation command when the host device outputs the block deactivation command indicating (or, related to) the target data block to the NAND flash memory device.

In example embodiments, a log block may not be assigned to a new data block until the host device outputs an in-ordered write command indicating the new data block, the new data block being generated by completing the garbage collection operation.

In example embodiments, the host device may output a device information request command to the NAND flash memory device when the host device is first connected to the NAND flash memory device.

In example embodiments, when the host device outputs the device information request command to the NAND flash memory device, the NAND flash memory device may output device information to the host device, and the host device may store the device information output from the NAND flash memory device.

In example embodiments, the non-volatile memory system may be implemented as a Solid State Drive (SSD), a Secure Digital Card (SDCARD), a Universal Flash Storage (UFS), or an Embedded Multi Media Card (EMMC).

Therefore, a non-volatile memory system according to example embodiments may enable a host device to accurately know (or, recognize) internal operation information of a NAND flash memory device and to efficiently control a garbage collection operation that is performed by the NAND flash memory device by including a first flash translation layer, which performs the garbage collection operation, in the NAND flash memory device and by including a file system and a second flash translation layer, which controls an operation of the NAND flash memory device by interacting with the file system, in the host device. As a result, the non-volatile memory system may perform a random write operation at high speed, and may minimize (or, reduce) power consumption due to unnecessary data transfer.

### BRIEF DESCRIPTION OF THE DRAWINGS

Illustrative, non-limiting example embodiments will be more clearly understood from the following detailed description taken in conjunction with the accompanying drawings.

FIGS. 1A through 1C are block diagrams illustrating a non-volatile memory system according to example embodiments.

FIG. 2 is a concept diagram illustrating an in-ordered write operation performed by a non-volatile memory system according to example embodiments.

FIGS. 3A and 3B are diagrams illustrating an example of an in-ordered write operation performed by a non-volatile memory system according to example embodiments.

FIGS. 4A through 4D are diagrams illustrating another example of an in-ordered write operation performed by a non-volatile memory system according to example embodiments.

FIGS. 5A and 5B are diagrams illustrating an example of a garbage collection operation performed by a non-volatile memory system according to example embodiments.

FIG. 6 is a flowchart illustrating an interaction between a host device and a NAND flash memory device performed by a non-volatile memory system according to example embodiments.

FIG. 7 is a diagram illustrating an interaction between a host device and a NAND flash memory device performed by a non-volatile memory system according to example embodiments.

### DETAILED DESCRIPTION OF THE EMBODIMENTS

Hereinafter, embodiments of the present inventive concept will be explained in detail with reference to the accompanying drawings.

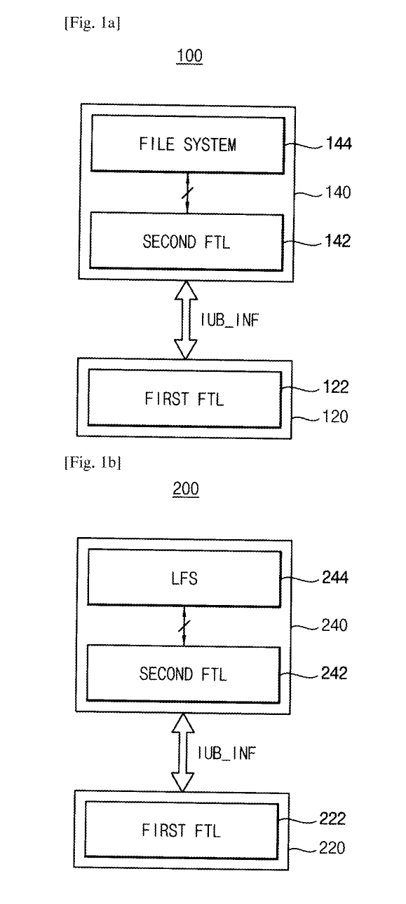

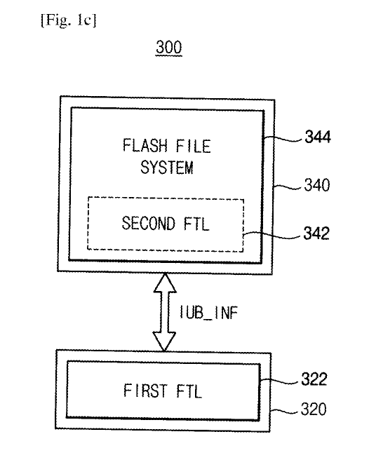

FIGS. 1A through 1C are block diagrams illustrating a non-volatile memory system according to example embodiments. For convenience of description, a non-volatile memory system according to example embodiments will be described focusing on the non-volatile memory system 100 of FIG. 1A.

Referring to FIG. 1A, the non-volatile memory system 100 may include a NAND flash memory device 120 and a host device 140. As illustrated in FIG. 1A, in the non-volatile memory system 100, a flash translation layer that controls an operation of the NAND flash memory device 120 may be divided into a first flash translation layer 122 and a second flash translation layer 142. Here, the first flash translation layer 122 may be included in the NAND flash memory device 120, and the second flash translation layer 142 may be included in the host device 140. Although the first and second flash translation layers 122 and 142 are recited above, the first and second flash translation layers 122 and 142 should be interpreted as various components each including at least one function of the flash translation layer that controls the operation of the NAND flash memory device 120.

The NAND flash memory device 120 may include a first flash translation layer 122 that performs a garbage collection operation. In an example embodiment, an address-mapping that is performed by the first flash translation layer 122 of the NAND flash memory device 120 may correspond to a block mapping. As described below, since the host device 140 provides application data in an in-ordered form to the NAND flash memory device 120, the address-mapping of the first flash translation layer 122 may be referred to as an in-ordered update block mapping. Here, the garbage collection operation may include at least one selected among a merging operation, a compaction operation, and a wear-leveling operation. However, the garbage collection operation should be interpreted as an operation including typical background operations of the NAND flash memory device 120. For convenience of description, it will be assumed below that the garbage collection operation is the merging operation. In an example embodiment, the NAND flash memory device 120 may be implemented as a Solid State Drive (SSD), a Secure Digital Card (SDCARD), a Universal Flash Storage (UFS), an Embedded Multi Media Card (EMMC), a compact flash (CF) card, a memory stick, an eXtreme Digital (XD) picture card, etc. Generally, in a conventional non-volatile memory system, a host device or a NAND flash memory device includes a typical flash translation layer for supporting a typical file system. On the other hand, in the non-volatile memory system 100, the host device 140 may include the second flash translation layer 142 that performs operations except for the garbage collection operation among all operations that are performed by the typical flash translation layer, and the NAND flash memory device 120 may include the first flash translation layer 122 that performs the garbage collection operation. Thus, the non-volatile memory system 100 may relatively take full advantages due to characteristics of the NAND flash memory device 120 (e.g., high performance, high reliability, etc). Although it is illustrated in FIG. 1A that the NAND flash memory device 120 includes the first flash translation layer 122, it should be understood that the NAND flash memory device 120 may further include hardware and/or software components such as a NAND controller, a NAND flash manager, etc.

The host device 140 may include a file system 144 and the second flash translation layer 142. The second flash translation layer 142 may control an operation of the NAND flash memory device 120 by interacting (or, communicating) with the file system 144. In an example embodiment, as illustrated in FIG. 1A, the file system 144 may correspond to a file system such as an Extended File System (Ext4), a New Technology File System (NTFS), etc. Here, the second flash translation layer 142 included in the host device 140 may provide application data (or, user data, etc) in an in-ordered form to the NAND flash memory device 120. In another example embodiment, as illustrated in FIG. 1B, the file system 244 included in the host device 240 may correspond to a file system having a log structure such as a Log-structured File System (LFS), etc. Here, the second flash translation layer 242 included in the host device 240 may provide the application data in an in-ordered form to the NAND flash memory device 220. In still another example embodiment, as illustrated in FIG. 1C, the file system 344 included in the host device 340 may correspond to a Flash File System different from conventional file systems. In particular, when the host device 300 includes the Flash File System, the Flash File System may further perform a function of the second flash translation layer 342. Here, the file system 344 included in the host device 340 may provide the application data in an in-ordered form to the NAND flash memory device 320.

Thus, the host device 140 may perform hardware and/or software processing operations to change a form of the application data to an in-ordered form. In some example embodiments, the host device 140 may output only an in-ordered write command to the NAND flash memory device 120 to provide the application data in an in-ordered form all the time. In some example embodiments, the host device 140 may selectively output the in-ordered write command or a normal write command to the NAND flash memory device 120 to selectively provide the application data in an in-ordered form. For example, when the host device 140 provides the in-ordered write command indicating a target data block (or, victim data block) to the NAND flash memory device 120, the NAND flash memory device 120 may perform an in-ordered write operation for the target data block in response to the in-ordered write command. Here, when a target page to be updated exists among valid pages included in the target data block, the NAND flash memory device 120 may program an update page for the target page after copying valid pages preceding the target page into a log block associated with the target data block (e.g., a copy-back operation).

Since the host device 140 includes the file system 144 and the second flash translation layer 142 and the file system 144 interacts with the second flash translation layer 142 in the host device 140, the host device 140 may accurately know (or, recognize) internal operation information of the NAND flash memory device 120, and may efficiently control the garbage collection operation that is performed by the NAND flash memory device 120. Meanwhile, the host device 140 may select target data blocks (or, victim data blocks) of the garbage collection operation that is performed in the NAND flash memory device 120 by using a block deactivation command (or, deactivate block command) related to an assignment of log blocks for the target data blocks. For example, when the host device 140 outputs the block deactivation command indicating the target data block to the NAND flash memory device 120, the NAND flash memory device 120 may perform the garbage collection operation for the target data block in response to the block deactivation command. As a result, a new data block may be generated by completing the garbage collection operation. Here, a log block may not be assigned (or, allocated) to the new data block until the host device 140 outputs an in-ordered write command indicating the new data block. Although it is illustrated in FIG. 1A that the host device 140 includes the second flash translation layer 142 and the file system 144, it should be understood that the host device 140 may further include hardware and/or software components such as a central processing unit (CPU), a cache, an operating system (OS), etc.

In a conventional non-volatile memory system, a host device includes a file system, a NAND flash memory device includes a flash translation layer, and the host device is connected to (or, communicates with) the NAND flash memory device by a logical block-based interface. Alternatively, a host device includes a file system and a flash translation layer, and the host device is connected to (or, communicates with) the NAND flash memory device by a native NAND interface. However, according to a structure in which the host device is connected to the NAND flash memory device by the logical block-based interface, the NAND flash memory device should include a large capacity memory device (or, large capacity cache) for the flash translation layer. In addition, the host device may not control the garbage collection operation of the NAND flash memory device because the host device may not accurately know (or, recognize) internal operation information of the NAND flash memory device. As a result, a selection of the target data blocks for the garbage collection operation may be inefficiently performed. Further, according to a structure in which the host device is connected to the NAND flash memory device by the native NAND interface, the host device may accurately know (or, recognize) the internal operation information of the NAND flash memory device because the file system interacts with the flash translation layer in the host device. However, since the garbage collection operation of the NAND flash memory device is performed at the host device level, unnecessary data transfer between the host device and the NAND flash memory device may be performed. In addition, since the application data in an in-ordered form is not provided from the host device to the NAND flash memory device in the conventional non-volatile memory system, the garbage collection operation may not be efficiently performed when an address-mapping that is performed by the flash translation layer corresponds to a block mapping.

To overcome these problems, as described above, the non-volatile memory system 100 may enable the host device 140 to accurately know (or, recognize) the internal operation information of the NAND flash memory device 120 and to efficiently control the garbage collection operation that is performed by the NAND flash memory device 120 (i.e., the first flash translation layer 122 included in the NAND flash memory device 120) by including the first flash translation layer 122, which performs the garbage collection operation, in the NAND flash memory device 120 and by including the file system 144 and the second flash translation layer 142, which performs many operations except for the garbage collection operation by interacting with the file system 144, in the host device 140. As a result, the non-volatile memory system 100 may perform a random write operation at high speed, and may minimize (or, reduce) power consumption due to unnecessary data transfer. In an example embodiment, when the host device 140 is first connected to the NAND flash memory device 120, the host device 140 may output a device information request command (or, get block geometry command) to the NAND flash memory device 120. In this case, the NAND flash memory device 120 may output device information (e.g., information related to a block size, a page size, etc) to the host device 140, and the host device 140 may store the device information. Meanwhile, an interface by which the host device 140 is connected to the NAND flash memory device 120 in the non-volatile memory system 100 may be referred to as an in-ordered update block interface (i.e., indicated as IUB-INF).

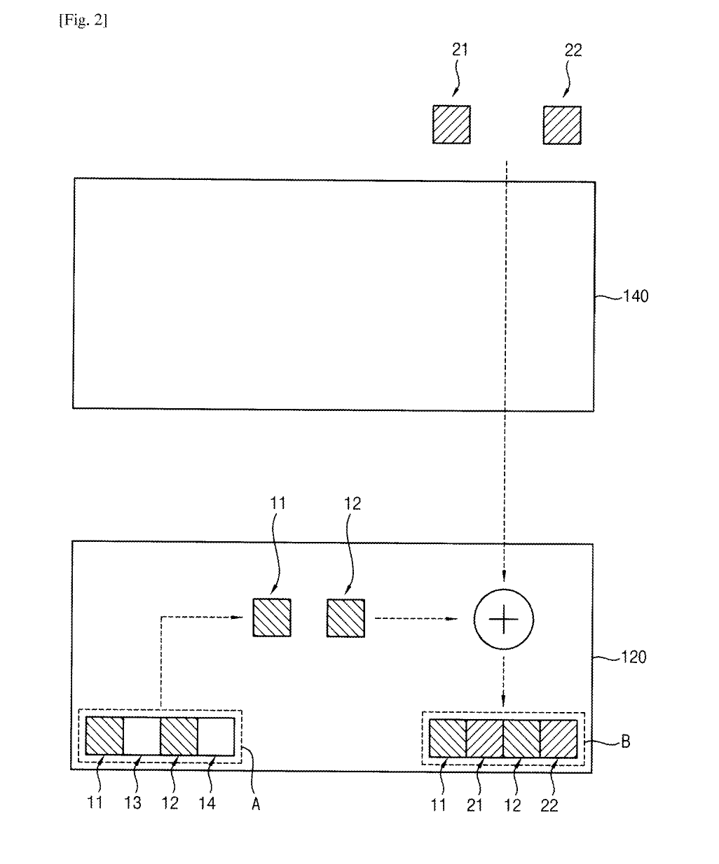

FIG. 2 is a concept diagram illustrating an in-ordered write operation performed by a non-volatile memory system according to example embodiments. For convenience of description, a non-volatile memory system according to example embodiments will be described focusing on the non-volatile memory system 100 of FIG. 1A.

Referring to FIG. 2, in the non-volatile memory system 100 of FIG. 1A, the host device 140 may be connected to the NAND flash memory device 120 by an in-ordered update block interface. As described above, the non-volatile memory system 100 of FIG. 1A may enable the host device 140 to output an in-ordered write command to the NAND flash memory device 120, and may enable the NAND flash memory device 120 to perform an in-ordered write operation based on the in-ordered write command. Here, the host device 140 may provide application data (or, user data, etc) in an in-ordered form to the NAND flash memory device 120.

A target data block ‘A’ may include a plurality of physical pages. In FIG. 2, for convenience of description, it is assumed that the target data block A includes four physical pages. In addition, when target pages (or, victim pages) 13 and 14 to be updated exist among valid pages 11, 13, 12, and 14 included in the target data block ‘A’, a log block ‘B’ for programming update pages 21 and 22 for the target pages 13 and 14 may be assigned (or, allocated). Specifically, when the host device 140 outputs an in-ordered write command indicating the target data block ‘A’ to the NAND flash memory device 120, the NAND flash memory device 120 may perform an in-ordered write operation for the target data block ‘A’. Here, since the application data in an in-ordered form is provided from the host device 140 to the NAND flash memory device 120, the NAND flash memory device 120 may sequentially program a plurality of logical pages corresponding to the application data in the target data block ‘A’ (i.e., in the order listed: 11, 13, 12, and 14). Subsequently, when the target pages 13 and 14 to be updated exist among the valid pages 11, 13, 12, and 14 included in the target data block ‘A’, the NAND flash memory device 120 may program the update page 21 for the target page 13 in the log block ‘B’ after copying the valid page 11 preceding the target page 13 into the log block ‘B’. Next, the NAND flash memory device 120 may copy the valid page 12 preceding the target page 14 into the log block ‘B’, and then may program the update page 22 for the target page 14 in the log block ‘B’. In some example embodiments, one log block ‘B’ may be assigned (or, allocated) to one target data block ‘A’. However, the number of assigned log blocks ‘B’ may be determined in various ways according to requirements of the NAND flash memory device 120 (e.g., may be determined by a system parameter). In this way, the NAND flash memory device 120 may continually perform an in-ordered write operation while assigning the log block ‘B’ to the target data block ‘A’. Then, when the host device 140 outputs a block deactivation command indicating the target data block ‘A’ to the NAND flash memory device 120, the NAND flash memory device 120 may perform the garbage collection operation for the target data block ‘A’ in response to the block deactivation command.

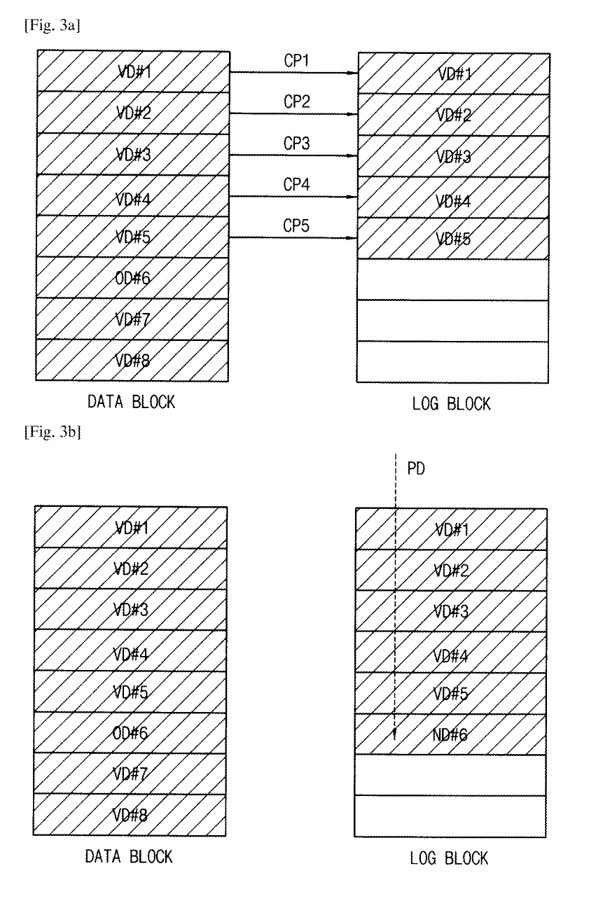

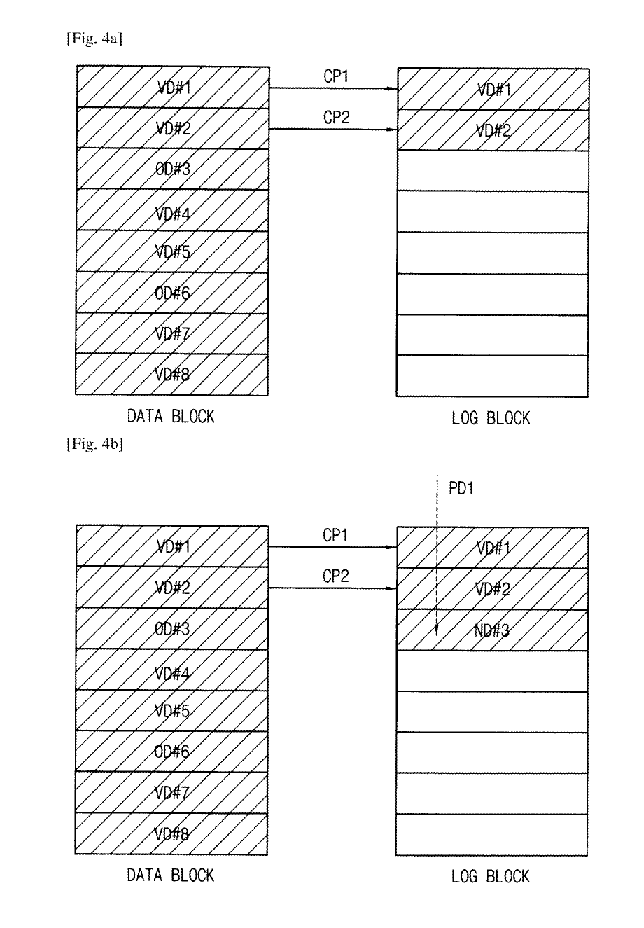

FIGS. 3A and 3B are diagrams illustrating an example of an in-ordered write operation performed by a non-volatile memory system according to example embodiments. For convenience of description, a non-volatile memory system according to example embodiments will be described focusing on the non-volatile memory system 100 of FIG. 1A.

Referring to FIGS. 3A and 3B, in the non-volatile memory system 100 of FIG. 1A, when the host device 140 outputs an in-ordered write command indicating a target data block to the NAND flash memory device 120, the NAND flash memory device 120 may perform an in-ordered write operation for the target data block. Here, a log block may be assigned (or, allocated) to the target data block in order to program an update page ND#6 for a target page OD#6 to be updated. As illustrated in FIG. 3A, when the target page OD#6 to be updated exists in the target data block, the NAND flash memory device 120 may copy valid pages VD#1 through VD#5 preceding the target page OD#6 into the log block. In other words, first through fifth copy-back operations CP1 through CP5 for the valid pages VD#1 through VD#5 may be sequentially performed. Next, as illustrated in FIG. 3B, the NAND flash memory device 120 may program the update page ND#6 at a location within the log block that is the same as a location of the target page OD#6 within the target data block. In other words, a program operation PD for the update page ND#6 may be performed. Here, since the host device 140 provides the application data in an in-ordered form to the NAND flash memory device 120, a probability that valid pages VD#7 and VD#8 subsequent to the target page OD#6 will be updated may be relatively high. In an example embodiment, a copy-back operation for the valid pages VD#7 and VD#8 subsequent to the target page OD#6 may not be performed for a predetermined time. In another example embodiment, the copy-back operation for the valid pages VD#7 and VD#8 subsequent to the target page OD#6 may not be performed until a block deactivation command indicating the target data block is provided from the host device 120.

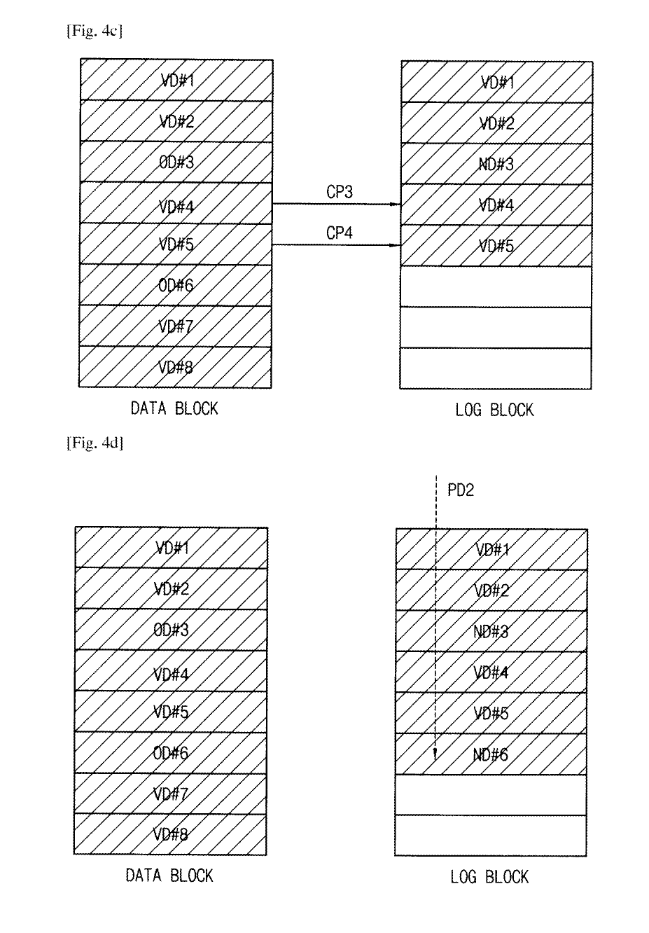

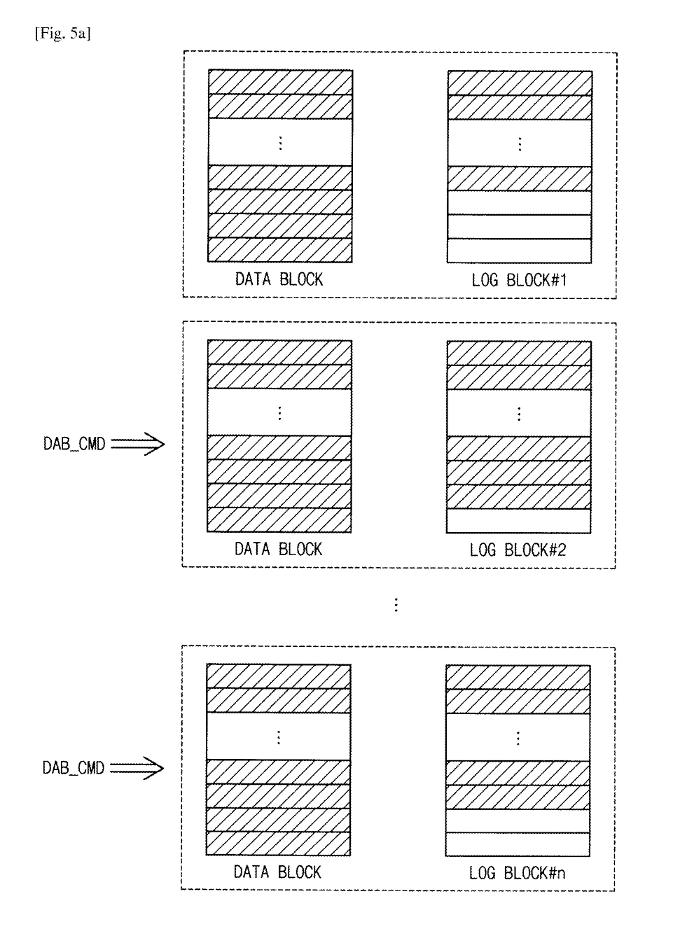

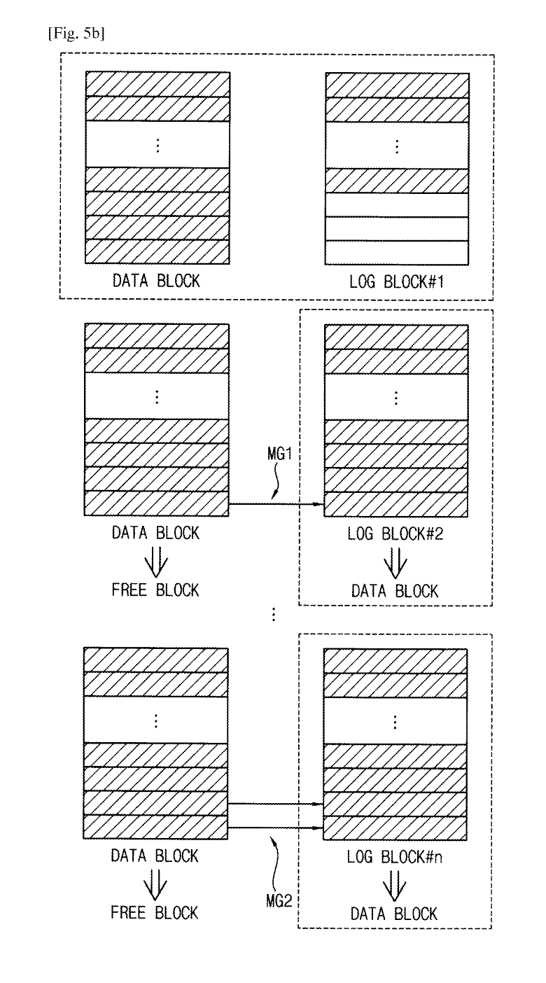

FIGS. 4A through 4D are diagrams illustrating another example of an in-ordered write operation performed by a non-volatile memory system according to example embodiments. For convenience of description, a non-volatile memory system according to example embodiments will be described focusing on the non-volatile memory system 100 of FIG. 1A.

Referring to FIGS. 4A through 4D, in the non-volatile memory system 100 of FIG. 1A, when the host device 140 outputs an in-ordered write command indicating a target data block to the NAND flash memory device 120, the NAND flash memory device 120 may perform an in-ordered write operation for the target data block. Here, a log block may be assigned (or, allocated) to the target data block in order to program update pages ND#3 and ND#6 for target pages OD#3 and OD#6 to be updated. As illustrated in FIG. 4A, when the target page OD#3 to be updated exists in the target data block, the NAND flash memory device 120 may copy valid pages VD#1 and VD#2 preceding the target page OD#3 into the log block. In other words, first and second copy-back operations CP1 and CP2 for the valid pages VD#1 and VD#2 may be sequentially performed. Next, as illustrated in FIG. 4B, the NAND flash memory device 120 may program the update page ND#3 at a location within the log block that is the same as a location of the target page OD#3 within the target data block. In other words, a first program operation PD1 for the update page ND#3 may be performed. Subsequently, as illustrated in FIG. 4C, the NAND flash memory device 120 may copy valid pages VD#4 and VD#5 preceding the target page OD#6 into the log block. In other words, third and fourth copy-back operations CP3 and CP4 for the valid pages VD#4 and VD#5 may be sequentially performed. Next, as illustrated in FIG. 4D, the NAND flash memory device 120 may program the update page ND#6 at a location within the log block that is the same as a location of the target page OD#6 within the target data block. In other words, a second program operation PD2 for the update page ND#6 may be performed. In an example embodiment, a copy-back operation for the valid pages VD#7 and VD#8 subsequent to the target page OD#6 may not be performed for a predetermined time. In another example embodiment, the copy-back operation for the valid pages VD#7 and VD#8 subsequent to the target page OD#6 may not be performed until a block deactivation command indicating the target data block is provided from the host device 120.

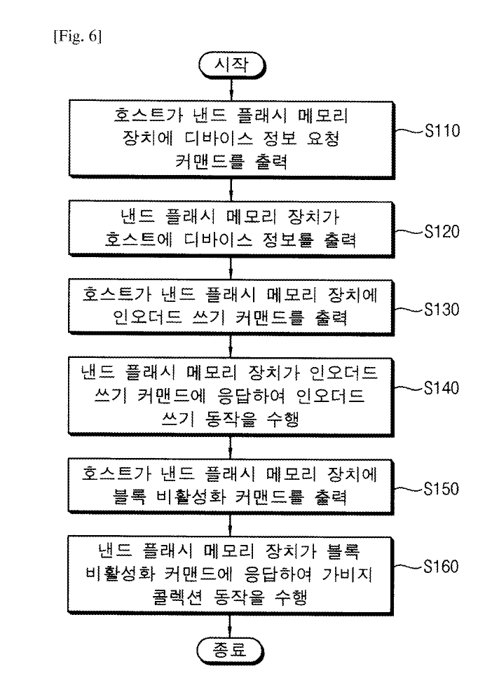

FIGS. 5A and 5B are diagrams illustrating an example of a garbage collection operation performed by a non-volatile memory system according to example embodiments. For convenience of description, a non-volatile memory system according to example embodiments will be described focusing on the non-volatile memory system 100 of FIG. 1A.

Referring to FIGS. 5A and 5B, in the non-volatile memory system 100 of FIG. 1A, when the host device 140 outputs a block deactivation command DAB-CMD indicating a target data block to the NAND flash memory device 120, the NAND flash memory device 120 may perform a garbage collection operation for the target data block in response to the block deactivation command DAB-CMD. As described above, since the host device 140 provides application data in an in-ordered form to the NAND flash memory device 120, a possibility that valid pages subsequent to a target page will be updated may be relatively high. Thus, as illustrated in FIG. 5A, the NAND flash memory device 120 may not perform a copy-back operation for the valid pages subsequent to the target page for a predetermined time or until the host device 120 provides a block deactivation command DAB-CMD indicating the target data block to the NAND flash memory device 120. Subsequently, as illustrated in FIG. 5B, when target data blocks are selected by the block deactivation command DAB-CMD, the garbage collection operation for the target data blocks (e.g., merging operations MG1 and MG2) may be performed to generate a new data block. Here, a log block may not be assigned (or, allocated) to the new data block until an in-ordered write command indicating the new data block is provided from the host device 140. In brief, in the non-volatile memory system 100 of FIG. 1A, the target data blocks may be selected based on the block deactivation command DAB-CMD, and then the garbage collection operation for the target data blocks may be performed. Meanwhile, since the host device 140 provides the application data in an in-ordered form to the NAND flash memory device 120, the merging operations MG1 and MG2 may be performed as a so-called copy-merging operation having smaller overhead amount compared to a so-called full-merging operation. In some example embodiments, when the garbage collection operation for the target data block indicated by the block deactivation command DAB-CMD is not required to be performed, a log block associated with the target data block may be changed to a new data block. Here, a log block may not be assigned (or, allocated) to the new data block until an in-ordered write command indicating the new data block is provided from the host device 140.

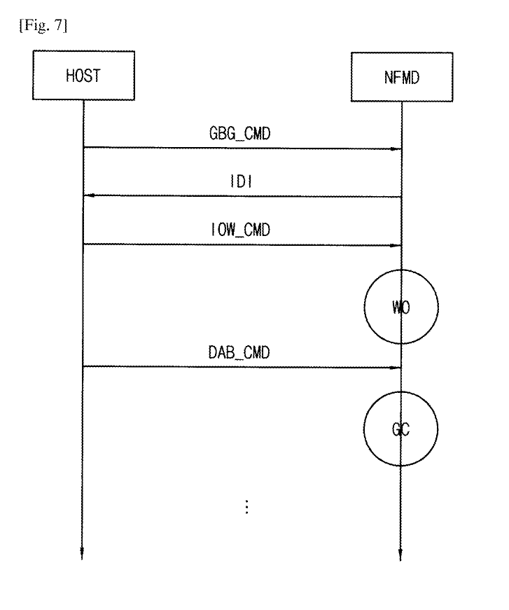

FIG. 6 is a flowchart illustrating an interaction between a host device and a NAND flash memory device performed by a non-volatile memory system according to example embodiments. FIG. 7 is a diagram illustrating an interaction between a host device and a NAND flash memory device performed by a non-volatile memory system according to example embodiments.

Referring to FIGS. 6 and 7, the host device HOST may output a device information request command GBG-CMD to the NAND flash memory device NFMD (S110) when the host device HOST is first connected to the NAND flash memory device NFMD. In response thereto, the NAND flash memory device NFMD may output device information IDI (e.g., information related to a block size, a page size, etc) to the host device HOST (S120). Here, the host device HOST may store the device information IDI. Subsequently, when the host device HOST outputs an in-ordered write command IOW-CMD indicating a target data block to the NAND flash memory device NFMD (S130), the NAND flash memory device NFMD may perform an in-ordered write operation WO for the target data block in response to the in-ordered write command IOW-CMD (S140). Here, the host device HOST may provide the application data in an in-ordered form to the NAND flash memory device NFMD. Next, when the host device HOST outputs the block deactivation command DAB-CMD indicating the target data block to the NAND flash memory device NFMD (S150), the NAND flash memory device NFMD may perform a garbage collection operation GC for the target data block in response to the block deactivation command DAB-CMD (S160). As described above, the non-volatile memory system may enable the host device HOST to accurately know (or, recognize) internal operation information of the NAND flash memory device NFMD and to efficiently control the garbage collection operation GC that is performed by the NAND flash memory device NFMD (e.g., to efficiently select target data blocks for which the garbage collection operation GC is performed) by including a first flash translation layer, which performs the garbage collection operation GC, in the NAND flash memory device NFMD and by including a file system and a second flash translation layer, which controls an operation of the NAND flash memory device NFMD by interacting with the file system, in the host device HOST. As a result, the non-volatile memory system may perform a random write operation at high speed, and may minimize (or, reduce) power consumption due to unnecessary data transfer. Although a non-volatile memory system according to example embodiments has been described with reference to FIGS. 1A through 7, those skilled in the art will readily appreciate that many modifications are possible in the example embodiments without materially departing from the novel teachings and advantages of the present inventive concept.

The present inventive concept may be applied to a non-volatile memory system including a NAND flash memory device. For example, the present inventive concept may be applied to a Solid State Drive (SSD), a Secure Digital Card (SDCARD), a Universal Flash Storage (UFS), an Embedded Multi Media Card (EMMC), a compact flash (CF) card, a memory stick, an eXtreme Digital (XD) picture card, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A non-volatile memory system, comprising:
a NAND flash memory device including a first flash translation layer that performs a garbage collection operation; and
a host device including a file system and a second flash translation layer that controls an operation of the NAND flash memory device by interacting with the file system,
wherein the host device provides application data in an in-ordered form to the NAND flash memory device.

2. The system of claim 1, wherein the garbage collection operation that is performed by the first flash translation layer includes at least one selected among a merging operation, a compaction operation, and a wear-leveling operation.

3. The system of claim 2, wherein the second flash translation layer of the host device provides the application data in the in-ordered form.

4. The system of claim 2, wherein the file system of the host device provides the application data in the in-ordered form.

5. The system of claim 2, wherein the NAND flash memory device performs an in-ordered write operation for a target data block in response to an in-ordered write command when the host device outputs the in-ordered write command indicating the target data block to the NAND flash memory device.

6. The system of claim 5, wherein when a target page to be updated exists among valid pages included in the target data block, the NAND flash memory device, the NAND flash memory device programs an update page for the target page after copying the valid pages preceding the target page into a log block associated with the target data block.

7. The system of claim 2, wherein the NAND flash memory device performs the garbage collection operation for a target data block in response to a block deactivation command when the host device outputs the block deactivation command indicating the target data block to the NAND flash memory device.

8. The system of claim 7, wherein a log block is not assigned to a new data block until the host device outputs an in-ordered write command indicating the new data block, the new data block being generated by completing the garbage collection operation.

9. The system of claim 2, wherein the host device outputs a device information request command to the NAND flash memory device when the host device is first connected to the NAND flash memory device.

10. The system of claim 9, wherein when the host device outputs the device information request command to the NAND flash memory device, the NAND flash memory device outputs device information to the host device, and the host device stores the device information output from the NAND flash memory device.
